(19) United States
(12) Patent Application Publication
(10) Pub. No.: US 2006/0179879 A1
(43) Pub. Date: Aug. 17, 2006

(54) Adjusting expansivity in doped silica glasses

(76) Inventors: Adam James Gillmar Ellison, Painted Post, NY (US); Kenneth Edward Hrdina, Horseheads, NY (US); Sabyasachi Sen, Davis, CA (US)

Correspondence Address: CORNING INCORPORATED, SP-TI-3-1, CORNING, NY, 14831, US

(21) Appl. No.: 11/316,293

(22) Filed: Dec. 21, 2005

Related U.S. Application Data
(60) Provisional application No. 60/640,400, filed on Dec. 29, 2004.

(51) Int. Cl. C03B 19/06; C03B 25/00

(52) U.S. Cl. 65/17.4; 65/117

(57) ABSTRACT

The invention is directed to ultra-low expansion glasses to which adjustments have been made to selected variables in order to improve the properties of the glasses, and particularly to lower the expansivity of the glasses. The glasses are titania-doped silica glasses. The variables being adjusted include an adjustment in β-OH level; an adjustment to the cooling rate of the molten glass material through the setting point; and the addition of selected dopants to impact the CTE behavior.

### PRIORITY

This application claims the priority and benefit of U.S. Provisional Application No. 60/640,400, filed Dec. 29, 2004 [29/12/2004] and titled ADJUSTING EXPANSIVITY IN DOPED SILICA GLASSES.

### FIELD OF THE INVENTION

The invention is directed to glass materials that can be used to make extreme ultraviolet lithographic (“EUVL”) elements for use in lithographic laser systems that operate below 200 nm and especially at 157 nm and below; and particularly for EUVL applications using reflective optics.

### BACKGROUND OF THE INVENTION

Advances in shrinking the size and reducing the electrical power requirements of electronic equipment while increasing the equipment's operational speed, processing power, range, and overall quality is dependent on the size of the transistors, the circuitry and other elements the semiconductor industry has been able to form in an integrated circuit pattern on a single chip. For example, several decades ago it required a room full of electronic equipment to perform the same functions performed by desktop or laptop computers available in 2004. In mobile telephony the equipment was the size of a large hardbound novel and performed fewer functions than today's palm-sized cell phones. These and other advances in electronics have occurred because component manufacturers have been continuously able to shrink the size of the transistors, the circuitry and other elements used in electronic equipment. The ability to perform such shrinkage is due to the use of lithographic methods which are basically a photographic technique that allows more and more features to be placed on a single chip without increasing the size of the chip. In the lithographic process light is directed onto a mask (a stencil of an integrated circuit pattern) and the mask image is projected onto a semiconductor wafer coated with a light sensitive photoresist material. In order to increase the density of elements in an integrated circuit the features of the elements must decrease without sacrificing performance. This requires the use of shorter and shorter wavelengths of light.

In the late 1990s the semiconductor industry was using a 248 nanometer (“nm”) wavelength to print 120-150 nm features on semiconductor chips. This process is being replaced by lithographic systems using 193 nm and 157 nm wavelengths (deep ultraviolet range) to make chips with elements in the 100-120 nm range. To make semiconductor chips with even smaller features will require the use of light in the extreme ultraviolet (“EUV”) range below approximately 120 nm. However, the use of EUV range light gives rise to a serious problem because the materials used for lenses in the 248, 193 and 157 nm lithographic systems absorb radiation in the EUV range instead of transmitting it. The result: no transmitted light and hence no image formed on the semiconductor wafer.

Extreme ultraviolet lithography (“EUVL”) utilizing radiation below approximately 120 nm will require a method that is completely different from that using 248, 193 and 157 nm radiation. For lithographic processes using 248 and 193 mm radiation, optical elements such stepper lenses could be made from very pure fused silica. At 157 nm the fused silica elements must be replaced by elements made from Group IIA alkaline earth metal fluorides, for example, calcium fluoride, because of absorption by silica at 157 nm. For the EUVL operating at approximately 120 nm or less, no isotropic materials exist that are transparent at these very short wavelengths. As a result, reflective optics must be used instead of conventional focusing optics. Reflective optics for EUVL are made by polishing the surface a substrate material such as silicon or glass to achieve the minimum degree of surface roughness; a proposed EUVL specification for roughness being on the order of <0.3 nm rms over a 10 mm spacing, with an eye toward a preferred specification of <0.2 nm rms over a 10 μm spacing. Multiple layers of reflective coating materials such as Mo/Be and Mo/Si are deposited on the substrate by magnetron sputtering or other suitable technique.

In an EUVL process the expansion/contraction properties of the reflective optics must be carefully controlled because of the very short wavelengths involved. In particular, it is critically important that the temperature sensitivity of the coefficient of thermal expansion (“CTE”) be kept as low as possible, and that the rate of change of the CTE with temperature be as low as possible in the normal operating temperature range of the lithographic process, which is in a general range of 4-40° C., preferably 20-25° C., with approximately 22° C. being the target temperature. At the present there are only two commercially available materials suitable for use as the substrate for reflectance optics that will satisfy both constraints. These are ULE® (Corning Incorporated, Corning, N.Y.) and ZERODUR® (Schott Lithotec AG, Mainz, Germany). While both are low expansion materials, ULE is a single-phase glass material that is easy to polish. ULE has a technical edge over ZERODUR in that the deliberate mixture of glass and crystal in ZERODUR (which is thus a two-phase material) makes it difficult to obtain a polish of the type required for this application. Consequently, in order for development of EUVL using reflective optics to proceed, what is needed a material with an improved CTE (coefficient of thermal expansion). The present invention describes an improved low expansion glass material with low expansivity that is suitable for use in reflective optics for EUVL applications.

### SUMMARY OF THE INVENTION

The present invention is directed to ultra-low expansion glasses to which adjustments have been made to selected variables in order to improve the properties of the glasses, and particularly to lower the expansivity of the glasses. The glasses are primarily titania-silica glasses and doped titania-silica glasses. The variables being adjusted include:

an adjustment in β-OH level (beta-OH test, a relative measure of hydroxyl concentration in silicate glasses);

the cooling rate of the molten glass material through the setting point; and

Selected dopants impact the CTE behavior (for example, Zr, Y, Al, Ce, Ta, Ge and F, and other dopants known in the art to impact CTE). The addition of a dopant will cause the absolute CTE to increase or decrease in the desired temperature range. However, this can be compensated with the addition or removal of some of the titania to lower or raise the absolute CTE, respectively. A lower slope to the expansivity is expected for the same absolute CTE. The addition of the dopants may lower the viscosity to a value low enough to allow forming to take place under ordinary batch melting conditions. Homogeneous thermal expansion values will be the result of uniform compositional control.

The invention is further directed to methods of forming the glass materials of the invention. Such methods include soot-to-glass, extrusion, sol-gel, PSD, and glass flow-out processes. In these methods, adjustments to β-OH are possible by adjusting the humidity of the helium used during consolidation of powder pre-forms. Samples consolidated in as-received helium yielded glass with 100 ppm β-OH. Humidifying the helium will yield glass with a water content of up to 1500 ppm, depending on the amount of humidity, and use of a drying agent such as Cl or F will yield glass with β-OH less than 100 ppm and down to 1 ppm or less. FIG. 6 identifies fused silica glasses in which the β-OH levels were adjusted by this method.

### BRIEF DESCRIPTION OF THE DRAWINGS

FIG. 1 illustrates the expansivity of a prior art ultra-low expansion glass to that that of a glass have “ideal” behavior.

FIG. 2 is an illustration one type of apparatus that can be used to make silica-titania glasses according to the invention.

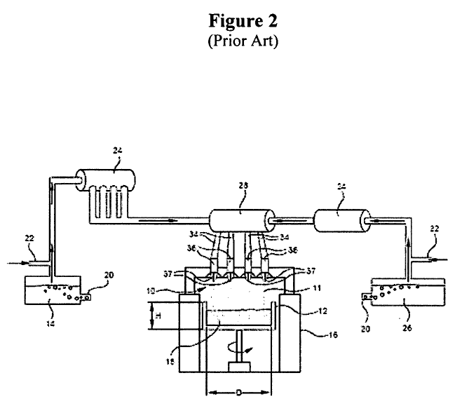

### DETAILED DESCRIPTION OF THE INVENTION

A concern of the users of EUV lithography systems is the control of the expansivity of the optics in the systems. Current standard ULE® Glass manufactured by Corning Incorporated has an expansivity that yields a slope of about 1.6 ppb/° K² at 20 C. To minimize distortions within the EUVL stepper system, it is desirous to reduce this slope to something less than 1.6 ppb/° K² and preferably approaching zero at temperatures between 20° C. and 30° C. In addition, if it desirous that the glass be as striae-free as possible. A process for preparing a striae-free titania-doped fused silica low expansion glass has been developed. This product has been aimed at the EUV market for photomasks. However, other applications are possible such as transmission optics

The present invention is directed to ultra-low expansion silica-titania glasses to which adjustments have been made to selected variables in order to improve the properties of the glasses, and particularly to lower the expansivity of the glasses. The glasses are primarily titania-doped silica glasses. The variables being adjusted include:

an adjustment in β-OH level (beta-OH test, a relative measure of hydroxyl concentration in silicate glasses);

the cooling rate of the molten glass material through the setting point; and

Selected dopants can be added to impact the CTE behavior (for example, Zr, Y, Al, Ce, Ta, Ge, Cl and F, and other dopants known in the art to impact CTE.

The addition of a dopant may cause the absolute CTE to increase or decrease at the desired temperature range. However, this can be compensated with the addition or removal of some of the titania to lower or raise the absolute CTE respectively. A lower slope to the expansivity is expected for the same absolute CTE. The addition of the dopants can also lower the viscosity to a value low enough to allow forming to take place under ordinary batch melting conditions. Homogeneous thermal expansion values will be the result of uniform compositional control. In an embodiment of the invention, metal dopants are supplied in the form of and organometallic compound and non-metal dopants are supplied in the form of an organic compound. Examples of organometallic compounds, without limitation, include metal alkoxides, alkyls, acetates, alkyl alkoxides [MRₓ(OR)_{y}, where R is alkyl, OR is alkoxide, and x and y are integers whose sum equals the valence of the metal]. Additionally, the dopants Cl and F can be supplied in the form of organic compound. Examples of such organic compounds include, without limitation, fluorocarbons, chlorofluorocarbons and chlorocarbons such as CFCl₃, CH₂Cl₂, CH₂F₂, CF₄ and similar compounds known in the art.

Titania content is the primary variable impacting CTE. Increases levels of titania result in decreased CTE values at room temperatures within ultra-low expansion glasses. The titania substitutes at a silica site and no bond breakage occurs which would have the like result higher CTE values. However, titanium is expected to vibrate in the transverse mode and thus will result in lower thermal expansion because increased levels of vibration from increasing temperatures pulls the structure together.

A secondary variable known to impact CTE in ultra-low expansion glasses is the cooling rate of the glass through the set point. Empirical data suggests that CTE decreases with faster cooling rates. Without being held to any particular theory, it is believed that this secondary effect is the result of increased strains frozen in the glass bonds (higher fictive temperatures) at faster cooling rates. The increases level of strained bonds results in lower CTE because titanium's transverse vibrations have a larger impact on CTE when the structure is strained.

In addition to the foregoing factors increasing the hydroxyl content in the silica-titania glass will have an impact on CTE. Increasing β-OH (β-OH test, a relative measure of the hydroxyl concentration in silicate glasses) can result in a larger number of broken bonds and thus a lower CTE.

Utilizing the teaching of the invention as described herein, a variety of methods that can be used to make silica-titania glass in accordance with the invention. Such methods include soot-to-glass, extrusion, sol-gel, PSD, and glass flow-out processes. In these methods, during the consolidation of powder preform, adjustments are made to β-OH by adjusting the humidity of an inert gas during consolidation of powder preforms. In the examples herein helium is used as the inert gas although other inert gases such as argon, krypton and nitrogen can be used. Glass pre-forms consolidated in as-received helium yielded glass with 100 ppm β-OH. Humidifying the helium can yield glass with a water content of up to 1500 ppm, and use of a drying agent such as Cl or F is expected to yield glass with β-OH less than 100 ppm, and down to 1 ppm or less depending on the mount of drying agent used in the process. Table 1 identifies fused silica glasses in which the β-OH levels were adjusted by this method. The results clearly show that one can achieve a wide range of β-OH using the method.

TABLE 1
β-OH Adjustment for Various Samples

| Sample No. | β-OH (ppm wt) |
|---|---|
| 1 | 9 |
| 2 | 6 |
| 3 | 55 |
| 4 | 155 |
| 5 | 362 |
| 6 | 570 |
| 7 | 572 |
| 8 | 1284 |

Table 2 compares ULE® glass properties with those specified for EUVL mask substrates or optics. The “+” sign in the Table indicates that the indicated property value is acceptable.

TABLE 2
ULE ® Properties

| Property | Mask Substrate | Optics |
|---|---|---|
| Thermal Hysteresis | + | + |
| Delayed Elasticity | + | + |
| Temporal Stability | + −0.07 ppb/day | + |
| Ability to Polish | + <0.15 nm rms | + |
| CTE Control | + (Class A) | + |
| CTE Homogeneity | + (Class A) | + |
| Non-Destructive CTE | + | ++ |

Class A means that the CTE has a value of 0±5 ppb/° C. Thermal expansivity is as defined in ASTM E228-95 and can be represented by the equation:
α_{T}=1/Lᵢ limit(L₂−L₁)/(T₂−T₁)=(dL/dT)/Lᵢ(T₁<Tᵢ<T₂)

where L is length, T is temperature and the “limit” is T₂→T₁. Thermal expansivity is also sometimes referred to as the instantaneous coefficient of linear expansion.

The glasses of the invention are silica-titania glasses wherein SiO₂ is in the range of 90-95 wt. % and TiO₂ is in the range of 5-10 wt. %. Dopants added to the glass are in the range of 500 to 10,000 ppm by weight (0.005-1 wt. %) with the weight of silica and titania being adjusted accordingly. The addition of the dopant may cause the absolute CTE to increase or decrease at the desired temperature range. However this can be compensated with the addition or removal of some of the titania to raise or lower the absolute CTE, respectively. Metal dopants as mentioned above are in the range 0.5 to 1.0 wt. % and non-metal dopant such as fluorine are in the range of 500 to 2000 ppm by weight. The addition of most materials to a pure fused silica glass (SiO₂ only) typically increases the thermal expansion of the glass. However, the objective of the present invention is not the impact of the dopant (or any impurities that may be present in the glass) on CTE, but the impact of the dopant on the expansivity. Additional titania can be added to a glass composition to decrease the impact of any dopant on CTE; or titania can be removed from the composition.

General Examples

The glass chemistry to achieve the invention can be accomplished in different ways. The following are given by way of illustration. As used herein the term “ambient temperature” means room temperature, generally, though not always, in the approximate range of 18-30° C.

Direct Fusion of Inorganic or Sol-Gel Derived Precursors

In this approach to forming a silica-titania low expansion glass, the desired compounds are combined together either through mechanical mixing or through precipitation from and aqueous or organic solvent. The compounds are dried or decomposed as appropriate and then heated using a ramping temperature cycle to a temperature that is sufficiently high to fuse the compounds into a final glass. In order to insure that the final glass is as free of defects as possible, the fusion is performed in the presence of water vapor, and inert gas (e.g., helium), hydrogen or under vacuum to eliminate gaseous inclusions. In addition it may be necessary to heat the glass to a final temperature above the devitrification temperature of the glass system, particularly in the case where the glass composition contains alkali metal cations which can promote surface devitrification of cristobalite at temperatures below the liquidus temperature of the glass. For an ultra-low expansion glass the practical peak temperature is approximately 1750° C. (±30° C.). The resulting fused, defect-free glass is slowly cooled to the anneal point (approximately 1100° C.) and held at this temperature for a time in the range of 4 hours to 4 days.

Soot Formation Followed by Consolidation

Suitable chemical precursors can be reacted together in a flame to produce a multi-component material composed of fine particles of relatively homogeneous glass. The fine glass particles are then consolidated into bulk glass by heating at a consolidation temperature, typically a temperature greater than 1600° C. To illustrate the invention, the following is an example of a method used to produce suitable glass chemistry. The precursors consist of an aqueous solution of water and one or more inorganic solutes, and an organic solution comprising organometallic compounds of silicon and titanium. These solution are delivered together through an atomizing burner assembly as disclosed in U.S. Pat. No. 6,565,823 titled “Method and Apparatus for Forming Silica by Combustion of Liquid Reactants; U.S. Pat. No. 6,312,656 titled “Method for Forming Silica by Combustion of Liquid Reactants Using Oxygen; and U.S. Pat. No. 6,672,106 titled “Method and Apparatus for forming Soot for the Manufacture of Glass”; all of whose specifications are incorporated herein by reference. In the method the aqueous and organic solutions are pre-mixed according to the desired stoichiometry. The aqueous solution may comprise water-soluble salts, for example alkali, alkaline earth, aluminum and rare earth element nitrates, carbonates, sulfates or acetate which are used as dopants. The organic solution comprises a liquid organometallic compound of siloxanes and alkoxides, alkylacetates and other compounds of silicon and titanium that compounds of silicon and titanium that are known in the art and can be dissolved in a suitable organic solvent.

The aqueous and organic solutions are delivered to the burner assembly in the desired ratios and atomized in the flame. The resulting soot stream is directed toward a target such as a rotating mandrel, a turntable of a stationary bait rod.

If the target is not heated to high temperature, this process results in a homogeneous soot body containing the desired quantities of oxides of the elements delivered by the aqueous and organic solutions. The soot body is heated to a relatively low temperature of approximately 1000° C. in the presence of helium, hydrogen, water vapor, or a dopant gas, for example CF₄ if fluorine is the desired dopant. The temperature is then ramped to the final consolidation temperature within the range of 1300° C. to the liquidus temperature of the composition which is usually about 1750° C. This process may be referred to as the “soot precursor approach”

If the target is heated or resides with a chamber or vessel which is heated, then the soot may reach such temperature that it melts directly into a uniform glass. This is referred to as a “soot-to-glass” method. The main advantage of the soot-to-glass method is the elimination of the secondary heat treatment, and this elimination results in a shortened processing time. A secondary advantage is that the final glass is much denser than glass made using the soot precursor method, and thus it may be possible to make larger boules of solid glass using the soot-to-glass method.

Plasma Method Using Organometallic or Inorganic Precursors

In this method crystalline or solid organometallic and/or inorganic precursors are injected into a plasma and then sprayed from the plasma chamber onto a target. This method provides good compositional flexibility because it requires only identification of the appropriate precursor materials and then injecting them into a plasma using a metering system. Suitable materials for the plasma include oxides, nitrates, carbonates, sulfates and other simple salts of silicon, titanium, alkali metals, alkaline earth metals, transition metals and rare earth metals. The simple salts can include fluorides and chlorides. Examples of such metals, without limitation, include Zr, Mo, Al, Y, Ce, Ta, and Ga. Once deposited these materials are made into a dense glass using soot-to-glass and soot precursor procedures described above. For example, the materials are deposited on a heated target where they melt directly into a uniform glass as is in the method.

Specific Example

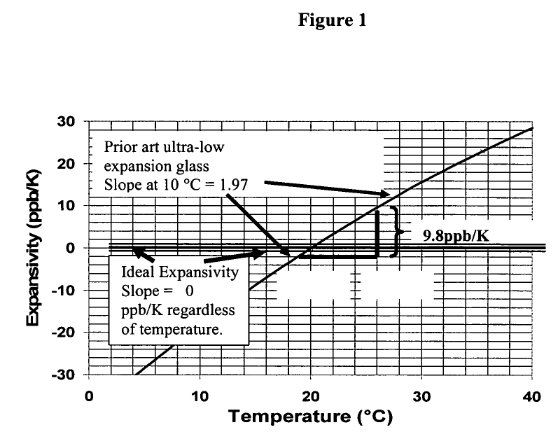

FIG. 1 illustrates the expansivity of a prior art ultra-low low expansion glass versus that of a glass having ideal behavior. The objective of the invention is to flatten the slope from 9.8 ppb/° K as illustrated to the ideal of 0 ppb/° K.

The glass exemplified by FIG. 1 can be made using the apparatus shown in FIG. 1, an apparatus for the manufacture of silica-titania glasses and a soot precursor method as follows. The method includes high purity silicon-containing feedstock or precursor 14 and high purity titanium-containing feedstock or precursor 26. The feedstock or precursor materials are typically siloxanes, alkoxides and tetrachlorides containing titanium or silicon. One particular commonly used silicon-containing feedstock material is octamethylcyclotetrasiloxane, and one particular commonly used titanium-containing feedstock material is titanium isopropoxide. An inert bubbler gas 20 such as helium or nitrogen is bubbled through feedstocks 14 and 26, to produce mixtures containing the feedstock vapors and carrier gas. An inert carrier gas 22 such as helium or nitrogen is combined with the silicon feedstock vapor and bubbler gas mixture and with the titanium feedstock vapor and bubbler gas mixture to prevent saturation and to deliver the feedstock materials 14, 26 to a conversion site 10 within furnace 16 through distribution systems 24 and manifold 28. The silicon feedstock and vapor and titanium feedstock and vapor are mixed in a manifold 28 to form a vaporous, titanium-containing silica glass precursor mixture which is delivered through conduits 34 to burners 36 mounted in the upper portion 38 of the furnace 16. A third bubbler feed system (not illustrated) is use to feed water vapor containing solutes through the feed system to the manifold where it is combined with the titanium and silicon feedstocks. Alternatively, the solute containing water can be atomized into the manifold or into the burner flame using a commercial atomizer system. The burners 36 produce burner flames 37. Conversion site burner flames 37 are formed with a fuel and oxygen mixture such as methane mixed with hydrogen and/or oxygen, which combusts, oxidizes and converts the feedstocks at temperatures greater than about 1600° C. into soot 11. The burner flames 37 also provide heat to consolidate the soot 11 into glass. The temperature of the conduits 34 and the feedstocks contained in the conduits are typically controlled and monitored in minimize the possibility of reactions prior to the flames 37.

The feedstocks are delivered to a conversion site 10, where they are converted into titania-containing silica soot particles 11. The soot 11 is deposited in a revolving collection cup 12 located in a refractory furnace 16 typically made from zircon and onto the upper glass surface of a hot titania-silica glass body 18 inside the furnace 16. The soot particles 11 consolidate into a titania-containing high purity silica glass body. [The apparatus can also be used to deliver a soot to a vessel that is below the consolidation temperature of the soot by removing the furnace from around the vessel or by sufficiently lowering the temperature of the vessel and any surface therein.]

The cup 12 typically has a circular diameter shape of between about 0.2 meters and 2 meters so that the glass body 18 is a cylindrical body having a diameter D between about 0.2 and 2 meters and a height H between about 2 cm and 20 cm. The weight percent of titania in the fused silica glass can be adjusted by changing the amount of either the titanium feedstock or silicon-containing feedstock delivered to the conversion site 10 that is incorporated into the soot 11 and the glass 18. The amount of titania and/or silica, and the amount of water vapor delivered to the system, is adjusted so that the glass body has a coefficient of thermal expansion of about zero at the operating temperature of an EUV or soft x-ray reflective lithography or mirror element. The slope of expansivity versus temperature curve for said glass is found to be less than 9.8 ppb/° K as illustrated in FIG. 1.

In one embodiment, the invention is directed to a method for making and adjusting the expansivity of a silica-titania ultra-low expansion glass, the method comprising making a silica-titania containing powder or powder preform using a silica precursor and a titanium precursor compound; consolidating the powder or powder preform into glass in the presence of an inert gas containing water vapor; lowering the temperature of the consolidated glass from a consolidation temperature to an annealing temperature, annealing the glass; and cooling the glass to ambient temperature to form an ultra-low expansion silica-titania glass having a β-OH level in ppm by weight in the rang of greater than 100 ppm to 1500 ppm.

In another embodiment the invention is directed to a method of making an ultra-low expansive glass suitable for use as a reflective optic substrate in extreme ultraviolet lithographic systems, said method comprising making a silica-titania glass by flame hydrolysis by supplying a silica precursor, a titania precursor and, optionally, a dopant precursor to a flame to form a soot; depositing the soot in a vessel whose temperature is below the consolidation temperature of the soot; consolidating the soot at a consolidation temperature in the presence of an inert gas containing water vapor to form a glass; lowering the temperature of the glass to an annealing temperature; annealing the glass; and lowering the temperature of the annealed glass to ambient temperature.

In additional embodiments, the silica precursor is a siloxanes or silicon alkoxide, and the titania precursor is a titanium alkoxide. Further, the dopants are selected from the group consisting of Zr, Y, Al, Ce, Ta, Ge, Mo, Cl and F; are present in an amount in the range of 0.005 to 1.0 wt. %; and metal dopants are supplied in the form of an organometallic compound and non-metal dopants are supplied in the form of an organic compound

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method for making and adjusting the expansivity of a silica-titania ultra-low expansion glass, the method comprising:
making a silica-titania containing powder or powder preform using a silica precursor and a titanium precursor compound;
consolidating the powder or powder preform into glass in the presence of an inert gas containing water vapor,
lowering the temperature of the consolidated glass from a consolidation temperature to an annealing temperature, annealing the glass; and
cooling the glass to ambient temperature to form an ultra-low expansion silica-titania glass having a β-OH level in ppm by weight in the range of greater than 100 ppm to 1500 ppm.

2. The method according to claim 2, wherein the inert gas is helium.

3. The method according to claim 1, wherein the slope of expansivity versus temperature curve for said glass is found to be less than 9.8 ppb/° K.

4. The method according to claim 1, wherein said glass is formed by flame hydrolysis of a silica precursor and a titania precursor in the presence of added water vapor contained one or a plurality of selected dopants.

5. The method according to claim 4, wherein said one or plurality of dopants is selected from the group consisting of Zr, Y, Al, Ce, Ta, Ge, Mo, Cl and F, and said dopants in total are present in an amount in the range of 0.005 to 1.0 wt. %.

6. The method according to claim 5, wherein metal dopants are present in an amount in the range of 0.5 to 1.0 wt.

7. The method according to claim 5, wherein non-metal dopants are present in an amount in the range of 0.005 to 0.02 wt.

8. The method according to claim 1, wherein the method is a plasma method and crystalline and/or solid organometallic and/or inorganic precursors are injected into the plasma and then sprayed from the plasma chamber onto a target.

9. A method of making an ultra-low expansive glass suitable for use as a reflective optic substrate in extreme ultraviolet lithographic systems, said method comprising:
making a silica-titania glass by flame hydrolysis by supplying a silica precursor, a titania precursor and, optionally, a dopant precursor to a flame to form a soot;
depositing the soot in a vessel whose temperature is below the consolidation temperature of the soot;
consolidating the soot at a consolidation temperature in the presence of an inert gas containing water vapor to form a glass;
lowering the temperature of the glass to an annealing temperature;
annealing the glass; and
lowering the temperature of the annealed glass to ambient temperature.

10. The method according to claim 9, wherein the silica precursor is selected from the group consisting of siloxanes, and silicon alkoxides, and the titania precursor is a titanium alkoxide.

11. The method according to claim 9, wherein the dopant is elected from the group consisting of Zr, Y, Al, Ce, Ta, Ge, Mo, Cl and F; and
said dopants in total are present in an amount in the range of 0.005 to 1.0 wt. %; and
metal dopants are supplied in the form of an organometallic compound and non-metal dopants are supplied in the form of an organic compound.

12. A method of making an ultra-low expansive glass suitable for use as a reflective optic substrate in extreme ultraviolet lithographic systems, said method comprising:
making a silica-titania glass by flame hydrolysis by supplying a silica precursor, a titania precursor and, optionally, a dopant precursor and water vapor to a flame to form a soot;
depositing the soot in a vessel whose temperature is at or above the consolidation temperature of the soot;
consolidating the soot at said consolidation temperature to form a glass;
lowering the temperature of the glass to an annealing temperature;
annealing the glass; and
lowering the temperature of the annealed glass to ambient temperature.

13. The method according to claim 10, wherein the silica precursor is selected from the group consisting of siloxanes, and silicon alkoxides, and the titania precursor is a titanium alkoxide.

14. The method according to claim 12, wherein the dopant is elected from the group consisting of Zr, Y, Al, Ce, Ta, Ge, Mo, Cl, and F; and
said dopants in total are present in an amount in the range of 0.005 to 1.0 wt. %; and
metal dopants are supplied in the form of and organometallic compound and non-metal dopants are supplied in the form of an organic compound.
